(19) United States
(12) Patent Application Publication
(10) Pub. No.: US 2006/0111191 A1
(43) Pub. Date: May 25, 2006

(54) Torque transfer system and method of using the same

(75) Inventor: Richard J. Wise, Kelowna (CA)

Correspondence Address: MORGAN LEWIS & BOCKIUS LLP, 1111 PENNSYLVANIA AVENUE NW, WASHINGTON, DC, 20004, US

(73) Assignee: Magnetic Torque International

(21) Appl. No.: 10/992,118

(22) Filed: Nov. 19, 2004

(51) Int. Cl. H02N 13/00

(52) U.S. Cl. 464/29

(57) ABSTRACT

A system for transferring rotational motion includes a first rotational shaft extending along a first axial direction, and a second rotational shaft disposed along a second axial direction and spaced apart from the first rotational shaft, wherein the first rotational shaft is magnetically coupled to the second rotational shaft.

### BACKGROUND OF THE INVENTION

1. Field of the Invention

The present invention relates to a torque transfer system and a method of using a torque transfer system, and more particularly, to a system and a method for transferring torque between physically disconnected rotating shafts.

2. Discussion of the Related Art

In general, transmission of rotational motion is accomplished by coupling rotating shafts using a combination of physically connected members. For example, in order to transfer rotational motion from a first rotational shaft to a second rotational shaft, either gears, belts, or chains are commonly used. However, due to mechanical friction between the physically connected members, significant amounts of heat are generated that causes premature failures of the physically connected members and increases costs and loss of productivity due to repairs. Moreover, although the mechanical friction may be reduced by supplying a lubricant to the physically connected members, operational speed of the physically connected members has a maximum upper limit, thereby severely limiting transfer of the rotational motion between the first and second rotational shafts.

In addition, safety devices are commonly implemented to prevent damage to the first and second rotation shafts, as well as to the physically connected members. For example, shear devices are commonly used that mechanically disconnect either the rotating shafts or physically connected members in the event that a maximum torque limit is achieved. Thus, in the event that the maximum torque limit is achieved, the shear device must be replaced, thereby increasing costs and decreasing productivity.

Furthermore, alignment of the first and second rotational shafts must be maintained at all times in order to prevent any shearing stresses on the rotational shafts. Moreover, any misalignment of the first and second rotational shafts will result in a transfer of corresponding shearing stresses to the physically connected members.

### SUMMARY OF THE INVENTION

Accordingly, the present invention is directed to a torque transfer system that substantially obviates one or more of the problems due to limitations and disadvantages of the related art.

An object of the present invention is to provide a system and method for transferring rotational motion and torque that prevents generation of heat and friction.

Another object of the present invention is to provide a system and method for transferring rotational motion and torque that includes a method for preventing damage to the system.

Another object of the present invention is to provide a system and method for transferring rotational motion and torque that prevents transmission of shearing stresses.

Another object of the present invention is to provide a system and method for transferring rotational motion and torque that includes a method for preventing transmission of shearing stresses.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system for transferring rotational motion includes a first rotational shaft extending along a first axial direction, and a second rotational shaft disposed along a second axial direction and spaced apart from the first rotational shaft, wherein the first rotational shaft is magnetically coupled to the second rotational shaft.

In another aspect, a method of transferring rotational motion includes rotating a first shaft about a first axial direction, and rotating a second shaft about a second axial direction, the second shaft disposed from the first shaft by a gap distance, wherein the rotation of the second shaft is caused by magnetic coupling to the first shaft.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a perspective plan view of an exemplary torque transfer system according to the present invention;

FIG. 2 is a side view of another exemplary torque transfer system according to the present invention;

FIG. 3 is a side view of another exemplary torque transfer system according to the present invention;

FIG. 4 is a side view of another exemplary torque transfer system according to the present invention; and

FIG. 5 is a side view of another exemplary torque transfer system according to the present invention.

### DETAILED DESCRIPTION OF THE PREFERRED EMBODIMENTS

Reference will now be made in detail to the preferred embodiments of the present invention, examples of which are illustrated in the accompanying drawings.

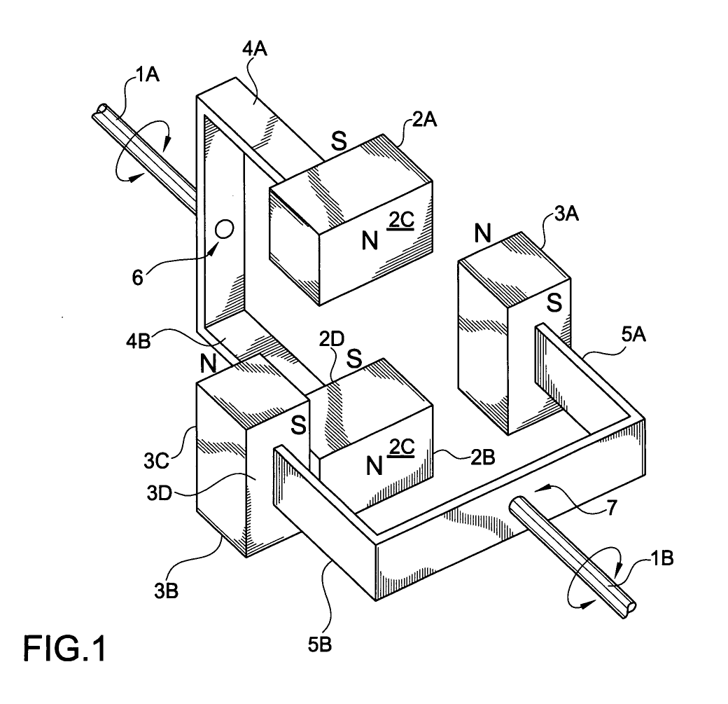

FIG. 1 is a perspective plan view of an exemplary torque transfer system according to the present invention. In FIG. 1, a torque transfer system may include a first rotational shaft 1A and a second rotational shaft 1B. Both the first and second rotational shafts 1A and 1B may be coupled to other devices that may make use of the rotational motion and torque transmitted by the first and second rotational shafts 1A and 1B. In addition, the first rotational shaft 1A may be coupled to a first pair of magnetic members 2A and 2B via first coupling arms 4A and 4B, respectively, using a shaft coupling 6. Similarly, the second rotational shaft 1B may be coupled to a second pair of magnetic members 3A and 3B via second coupling arms 5A and 5B, respectively, using a shaft coupling 7. Accordingly, the first pair of magnetic members 2A and 2B may be aligned with each other along a first direction, and the second pair of magnetic members 3A and 3B may be aligned with each other along a second direction perpendicular to the first direction. The first and second coupling arms 4A/4B and 5A/5B may be made of non-magnetic material(s), thereby preventing any adverse reaction with the first and second magnetic members 2A/2B and 3A/3B. Of course, if the first and second rotational shafts 1A and 1B are made of non-magnetic material(s), then the first and second coupling arms 4A/4B and 5A/5B may not be necessary. Thus, the first and second magnetic members 2A/2B and 3A/3B may be configured to be coupled to the first and second rotational shafts 1A and 1B using a rotational disks, thereby providing improved rotational stabilization and improved precision.

In FIG. 1, the first pair of magnetic members 2A and 2B may have a polar orientation such that first faces 2C of the first pair of magnetic members 2A and 2B are magnetic North poles facing toward the second pair of magnetic members 3A and 3B, and second faces 2D of the first pair of magnetic members 2A and 2B face toward the first rotational shaft 1A. In addition, the second pair of magnetic members 3A and 3B may have a polar orientation such that first faces 3C of the second pair of magnetic members 3A and 3B North poles face toward the first pair of magnetic members 2A and 2B, and second faces 3D of the second pair of magnetic members 3A and 3B that face toward the second rotational shaft 1A. Accordingly, the opposing first faces 2C and 3C of the first and second magnetic members 2A/2B and 3A/3B, respectively, may have like polar orientation. Although FIG. 1 shows that the opposing first faces 2C and 3C of the first and second magnetic members 2A/2B and 3A/3B, respectively, may have North magnetic polar orientations, the opposing first faces 2C and 3C of the first and second magnetic members 2A/2B and 3A/3B, respectively, may have South magnetic polar orientations.

Accordingly, as the first rotational shaft 1A rotates about a first axial direction, the second magnetic members 3A and 3B are repelled by the first magnetic members 2A and 2B, thereby rotating the second rotational shaft 1B about a second axial direction identical to the first axial direction. Conversely, as rotation of the first rotational shaft 1A is reduced or increased along the first axial direction, rotation of the second rotational shaft 1B is reduced or increased by a direct correlation. Thus, as rotational torque increases or decreases along the first rotational shaft 1A, a corresponding amount of rotational torque may increase or decrease along the second rotational shaft 1B.

However, if the amount of torque transmitted along the first rotational shaft 1A abruptly stops or abruptly increases, the magnetic repulsion between the first and second magnetic members 2A/2B and 3A/3B may be overcome. Accordingly, the first rotational shaft 1A may actually rotate at least one-half of a revolution with respect to rotation of the second rotational shaft 1B. Thus, the abrupt stoppage or increase of the torque transmitted along the first rotational shaft 1A may be accommodated by the first and second magnetic members 2A/2B and 3A/3B, thereby preventing any damage to the second rotational shaft 1B. In other words, if the change of transmitted torque exceeds the magnetic repulsion of the first and second magnetic members 2A/2B and 3A/3B, then the second rotational shaft 1B may “slip” in order to accommodate the change in torque. As compared to the related art, no shearing device may be necessary in order to prevent damage to the second rotational shaft 1B by the abrupt stoppage or increase of the torque transmitted along the first rotational shaft 1A.

In addition, since no additional mechanical members are necessary to transmit the rotational motion, as well as rotational torque, from the first rotational shaft 1A to the second rotational shaft 1B, heat is not generated nor is any noise generated. Thus, according to the present invention, no heat signature is created nor is any traceable noise generated. Thus, the present invention is applicable to systems that require stealth operation.

According to the present invention, various types and configurations of magnetic members may be implemented to achieve the same transfer of rotational torque from one shaft to another shaft. For example, the geometric shape and size of the first and second magnetic members 2A/2B and 3A/3B may be changed in order to provide specific magnetic coupling of the first and second rotational shafts 1A and 1B. Thus, the geometric shape and size of the first and second magnetic members 2A/2B and 3A/3B may include curved magnets, circular magnets, or non-linear geometries. Moreover, each of the first magnetic members 2A and 2B may have a first geometry and size and each of the second magnetic members 3A and 3B may have a second geometry and size different from the first geometry and size.

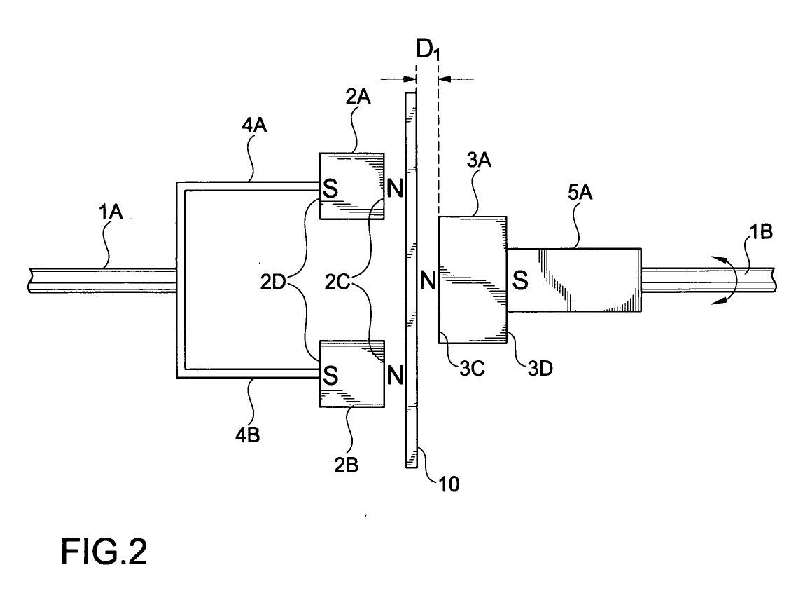

FIG. 2 is a side view of another exemplary torque transfer system according to the present invention. In FIG. 2, each of the first and second magnetic members 2A/2B and 3A/3B may be disposed on either side of a barrier 10. Accordingly, the barrier 10 may be made from non-magnetic material(s), thereby preventing interference with the magnetic fields of the first and second magnetic members 2A/2B and 3A/3B. Moreover, each of the first and second magnetic members 2A/2B and 3A/3B may be spaced apart from the barrier 10 by a distance D1 along opposing side surfaces of the barrier 10. Accordingly, the distance D1 may be adjusted to provide specific magnetic field coupling strengths between the first and second magnetic members 2A/2B and 3A/3B. In addition, a thickness of the barrier may be adjusted to also provide specific magnetic field coupling strength between the first and second magnetic members 2A/2B and 3A/3B. Furthermore, the barrier 10 may comprise a composite of different materials that may provide specific magnetic field coupling strength between the first and second magnetic members 2A/2B and 3A/3B. In either event, the spacing D1 and/or the barrier 10, and barrier material(s), may be selected to provide specific magnetic field coupling strength between the first and second magnetic members 2A/2B and 3A/3B.

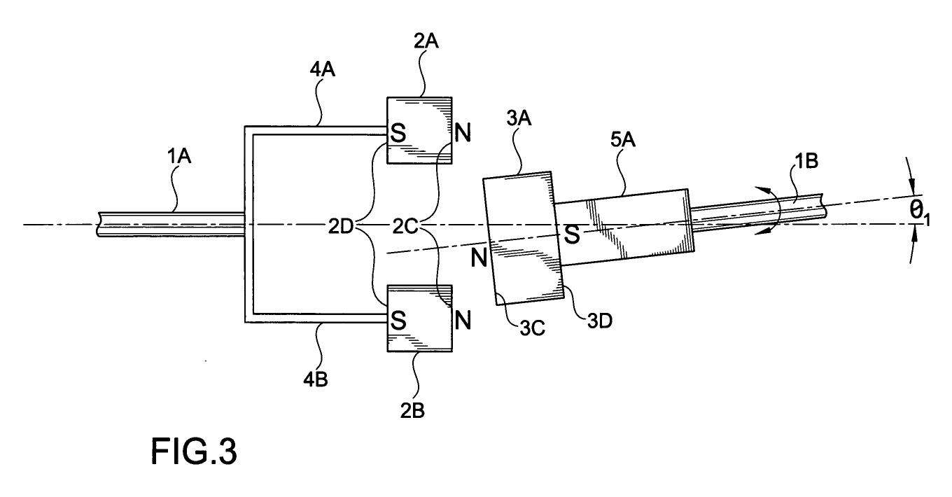

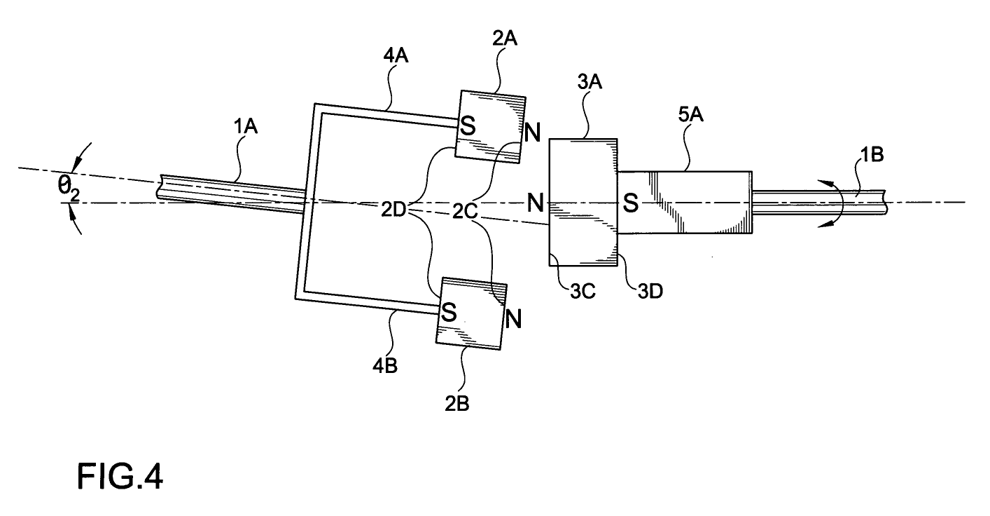

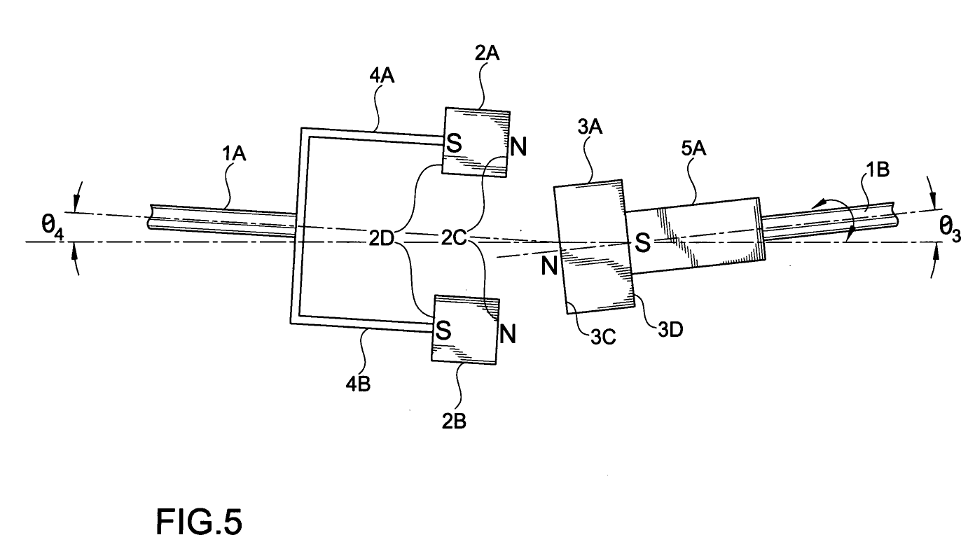

FIG. 3 is a side view of another exemplary torque transfer system according to the present invention. In FIG. 3, the first and second rotational shafts 1A and 11B may be offset from one another by an angle θ₁, wherein the first rotational shaft 1A extends along a first axial direction and the second rotational shaft 1B extends along a second axial direction that differs from the first axial direction by the angle θ₁. Accordingly, the first faces 3C of the second pair of magnetic members 3A and 3B may be skewed (i.e., antiparallel) from the first faces 2C of the first pair of magnetic members 2A and 2B. Thus, the offset of the first and second rotational shafts 1A and 1B may be accommodated by an adjustment of the repelling magnetic fields between the first and second pairs of magnetic members 2A/2B and 3A/3B. Moreover, as shown in FIG. 4, the first and second rotational shafts 1A and 1B may be offset from one another by an angle θ₂, wherein the first rotational shaft 1A extends along a first axial direction and the second rotational shaft 1B extends along a second axial direction that differs from the first axial direction by the angle θ₂. Furthermore, as shown in FIG. 5, the first and second rotational shafts 1A and 1B may be mutually offset from a center line angles of θ₃ and θ₄, wherein the first rotational shaft 1A extends along a first axial direction offset from a center line by the angle θ₄ and the second rotational shaft 1B extends along a second axial direction offset from the center line by the angle θ₃ that may, or may not differ from the angle θ₄.

In FIGS. 3, 4, and 5, the angles θ₁, θ₂, θ₃, and θ₄ may all be the same or may be different from each other. For example θ₁, θ₂, θ₃, and θ₄ may be within a range from slightly more than 0 degrees to slightly less than 45 degrees. Accordingly, the magnetic strengths of the first and second pairs of magnetic members 2A/2B and 3A/3B, as well as the distances separating the first and second pairs of magnetic members 2A/2B and 3A/3B, may determine the ranges for the angles θ₁, θ₂, θ₃, and θ₄. Furthermore, the distances between the first faces 3C of the second pair of magnetic members 3A and 3B and the first faces 2C of the first pair of magnetic members 2A and 2B may determine the ranges for the angles θ₁, θ₂, θ₃, and θ₄.

Although not shown in FIGS. 3, 4, and 5, a barrier (similar to the barrier 10, in FIG. 2), may be disposed between the first and second pairs of magnetic members 2A/2B and 3A/3B. In addition, the barrier (not shown) may not necessarily be a flat-type barrier, but may have a plurality of different geometries. For example, the barrier (not shown) may be formed of a curved surface or a non-linear surface.

It will be apparent to those skilled in the art that various modifications and variations can be made in the torque transfer system of the present invention without departing from the spirit or scope of the invention. Thus, it is intended that the present invention cover the modifications and variations of this invention provided they come within the scope of the appended claims and their equivalents.

1. A system for transferring rotational motion, comprising:
a first rotational shaft extending along a first axial direction; and
a second rotational shaft disposed along a second axial direction and spaced apart from the first rotational shaft,
wherein the first rotational shaft is magnetically coupled to the second rotational shaft.

2. The system according to claim 1, wherein the magnetic coupling of the first and second rotational shafts includes a plurality of magnets disposed to have repelling forces therebetween.

3. The system according to claim 2, wherein the plurality of magnets includes a first pair of magnetic members disposed along a second planar direction perpendicular to the first axial direction on the first rotational shaft, and a second pair of magnetic members disposed along a third planar direction perpendicular to the second axial direction and the second planar direction.

4. The system according to claim 3, wherein the first pair of magnetic members are attached to the first rotational shaft by a first pair of coupling arms, and the second pair of magnetic members are attached to the second rotational shaft by a second pair of coupling arms.

5. The system according to claim 2, wherein the plurality of magnets includes a first plurality of magnetic members coupled to the first rotational shaft, and a second plurality of magnetic members coupled to the second rotational shaft.

6. The system according to claim 5, wherein the first plurality of magnetic members have first faces having a first magnetic orientation, and the second plurality of magnetic members have first faces having the first magnetic orientation.

7. The system according to claim 6, wherein the first faces of the first plurality of magnetic members oppose the first faces of the second plurality of magnetic members to provide the repelling force.

8. The system according to claim 7, further comprising a barrier disposed between the opposing first faces of the first and second plurality of magnetic members.

9. The system according to claim 7, wherein the opposing first faces of the first and second plurality of magnetic members are parallel.

10. The system according to claim 7, wherein the opposing first faces of the first and second plurality of magnetic members are antiparallel.

11. The system according to claim 1, further comprising a barrier disposed between the first and second rotational shafts.

12. The system according to claim 11, wherein the barrier includes non-magnetic material.

13. The system according to claim 12, wherein the non-magnetic material includes a plurality of different materials.

14. The system according to claim 1, wherein the first axial direction is parallel to the second axial direction.

15. The system according to claim 14, wherein the magnetic coupling of the first and second rotational shafts includes a plurality of magnets disposed to have repelling forces therebetween.

16. The system according to claim 15, wherein the plurality of magnets includes a first pair of magnetic members disposed along a second planar direction perpendicular to the first axial direction on the first rotational shaft, and a second pair of magnetic members disposed along a third planar direction perpendicular to the second axial direction and the second planar direction.

17. The system according to claim 1, wherein the first axial direction is offset from the second axial direction by a first angle.

18. The system according to claim 17, wherein the magnetic coupling of the first and second rotational shafts includes a plurality of magnets disposed to have repelling forces therebetween.

19. The system according to claim 18, wherein the plurality of magnets includes a first pair of magnetic members disposed along a second planar direction perpendicular to the first axial direction on the first rotational shaft, and a second pair of magnetic members disposed along a third planar direction perpendicular to the second axial direction and the second planar direction.

20. The system according to claim 1, wherein the first axial direction and the second axial direction are mutually offset from a center line by a first angle and a second angle.

21. The system according to claim 20, wherein the first angle and the second angle are the same.

22. The system according to claim 20, wherein the first angle and the second angle are different.

23. A method of transferring rotational motion, comprising:
rotating a first shaft about a first axial direction; and
rotating a second shaft about a second axial direction, the second shaft disposed from the first shaft by a gap distance,
wherein the rotation of the second shaft is caused by magnetic coupling to the first shaft.

24. The method according to claim 23, wherein the magnetic coupling of the first and second shafts includes a plurality of magnets disposed to have repelling forces therebetween.

25. The method according to claim 24, wherein the plurality of magnets includes a first pair of magnetic members disposed along a second planar direction perpendicular to the first axial direction on the first rotational shaft, and a second pair of magnetic members disposed along a third planar direction perpendicular to the second axial direction and the second planar direction.

26. The method according to claim 25, wherein the first pair of magnetic members are attached to the first rotational shaft by a first pair of coupling arms, and the second pair of magnetic members are attached to the second rotational shaft by a second pair of coupling arms.

27. The method according to claim 24, wherein the plurality of magnets includes a first plurality of magnetic members coupled to the first rotational shaft, and a second plurality of magnetic members coupled to the second rotational shaft.

28. The method according to claim 27, wherein the first plurality of magnets have first faces having a first magnetic orientation and the second plurality of magnets have first faces having the first magnetic orientation.

29. The method according to claim 28, wherein the first faces of the first plurality of magnets oppose the first faces of the second plurality of magnets to provide the repelling force.

30. The method according to claim 29, further comprising placing a barrier between the opposing first faces of the first and second plurality of magnetic members.

31. The method according to claim 29, wherein the opposing first faces of the first and second plurality of magnetic members are parallel.

32. The method according to claim 29, wherein the opposing first faces of the first and second plurality of magnetic members are antiparallel.

33. The method according to claim 23, further comprising disposing a barrier between the first and second rotational shafts.

34. The method according to claim 33, wherein the barrier includes non-magnetic material.

35. The method according to claim 34, wherein the non-magnetic material includes a plurality of different materials.

36. The method according to claim 23, wherein a rotational torque of the first shaft is greater than the magnetic coupling of the first and second shafts.

37. The method according to claim 36, wherein a rotational speed of the first shaft is greater than a rotational speed of the second shaft.

38. The method according to claim 23, wherein the first axial direction is parallel to the second axial direction.

39. The method according to claim 38, wherein the magnetic coupling of the first and second rotational shafts includes a plurality of magnets disposed to have repelling forces therebetween.

40. The method according to claim 39, wherein the plurality of magnets includes a first pair of magnetic members disposed along a second planar direction perpendicular to the first axial direction on the first rotational shaft, and a second pair of magnetic members disposed along a third planar direction perpendicular to the second axial direction and the second planar direction.

41. The method according to claim 23, wherein the first axial direction is offset from the second axial direction by a first angle.

42. The method according to claim 41, wherein the magnetic coupling of the first and second rotational shafts includes a plurality of magnets disposed to have repelling forces therebetween.

43. The method according to claim 42, wherein the plurality of magnets includes a first pair of magnetic members disposed along a second planar direction perpendicular to the first axial direction on the first rotational shaft, and a second pair of magnetic members disposed along a third planar direction perpendicular to the second axial direction and the second planar direction.

44. The method according to claim 23, wherein the first axial direction and the second axial direction are mutually offset from a center line by a first angle and a second angle.

45. The method according to claim 44, wherein the first angle and the second angle are the same.

46. The method according to claim 44, wherein the first angle and the second angle are different.
